(19) United States
(12) Patent Application Publication
(10) Pub. No.: US 2018/0086885 A1
(43) Pub. Date: Mar. 29, 2018

(54) FABRICATION OF PATTERNED NANOPARTICLE STRUCTURES

(71) Applicants: Alamgir Karim, Akron, OH (US); Ren Zhang, Chandler, AZ (US)

(72) Inventors: Alamgir Karim, Akron, OH (US); Ren Zhang, Chandler, AZ (US)

(21) Appl. No.: 15/712,817

(22) Filed: Sep. 22, 2017

Related U.S. Application Data
(60) Provisional application No. 62/398,562, filed on Sep. 23, 2016.

(51) Int. Cl. C08J 3/12; B82Y 30/00

(52) U.S. Cl. CPC C08J 3/124; C08F 20/18; B82Y 30/00

(57) ABSTRACT

A polymer nanocomposite includes a polymer matrix with nanoparticle assemblies and free polymer chains. The nanoparticle assemblies have a size larger than the radius of gyration of the free polymer chains. The polymer nanocomposite includes patterns having nanoparticle assemblies selectively migrated therein. A method of making the polymer nanocomposite includes positioning a patterned object on a nanoparticle assembly-containing film.

### CROSS-REFERENCE TO RELATED APPLICATIONS

This application claims the benefit of U.S. Provisional Application No. 62/398,562, filed Sep. 23, 2016, which is incorporated herein by reference.

### FIELD OF THE INVENTION

The present invention relates to fabrication of patterned nanoparticle-containing materials.

### BACKGROUND OF THE INVENTION

Microfabrication and nanofabrication techniques have been implemented in many science and engineering fields, such as material science, computer science, and biomedical science. The superior functions of these microscale and nanoscale techniques come from the unique properties of materials at these small scales.

Microfabrication and nanofabrication techniques include ‘top-down’ and ‘bottom-up’ approaches. ‘Top-down’ approaches include photolithography, soft-lithography, nanoimprint, and electron beam lithography. ‘Bottom-up’ techniques include self-organization of atoms or molecules to construct the macroscopic structures. Examples of ‘bottom-up’ techniques include chemical and physical vapor deposition, and sol-gel nanofabrication.

However, presently known techniques are limited. For instance, one limitation is the nanoscale resolution that can be achieved. Another limitation relates to production difficulties, such as longer times, higher costs, and lack of scalability. Perhaps most importantly, most of the current techniques lack broad applicability for different material systems.

Thus, there remains a need for an efficient, economic, and universal technique for microfabrication and nanofabrication.

### SUMMARY OF THE INVENTION

In a first embodiment, the present invention provides a polymer nanocomposite comprising a polymer matrix having nanoparticle assemblies and free polymer chains, the free polymer chains having a radius of gyration size, each of the nanoparticle assemblies having polymers tethered to a nanoparticle, the nanoparticle assemblies having a size larger than the radius of gyration of the free polymer chains.

In a second embodiment, the present invention provides a polymer composite as in any of the above embodiments, the tethered polymers of the nanoparticle assemblies having a thickness extending from the outer surface of the nanoparticle to the outer surface of the tethered polymers, wherein the tethered polymer thickness is at least two times greater than the radius of gyration of the free polymer chains.

In a third embodiment, the present invention provides a polymer composite as in any of the above embodiments, the tethered polymers of the nanoparticle assemblies having a thickness extending from the outer surface of the nanoparticle to the outer surface of the tethered polymers, wherein the tethered polymer thickness is less than the radius of gyration of the free polymer chains.

In a fourth embodiment, the present invention provides a polymer composite as in any of the above embodiments, wherein the nanoparticles are spherical and have a radius of that is greater than the radius of gyration of the free polymer chains.

In a fifth embodiment, the present invention provides a polymer composite as in any of the above embodiments, wherein the nanoparticles are spherical and have a radius of 100 nm or less.

In a sixth embodiment, the present invention provides a polymer composite as in any of the above embodiments, wherein the nanoparticles are non-spherical and have at least one dimension of 100 nm or less.

In a seventh embodiment, the present invention provides a polymer composite as in any of the above embodiments, the nanoparticle assemblies having a radius extending from the center of the nanoparticle to the outer surface of the tethered polymers, the radius of the nanoparticle assemblies being in the range of from 5 nm to 5 μm.

In an eighth embodiment, the present invention provides a polymer composite as in any of the above embodiments, the polymer nanocomposite having a first protruding pattern and a second protruding pattern, a trench section extending between the first protruding pattern and the second protruding pattern, the first protruding pattern and the second protruding pattern each having a higher composition of nanoparticle assemblies than the trench section.

In a ninth embodiment, the present invention provides a polymer composite as in any of the above embodiments, the nanoparticle assemblies including a first subset of nanoparticle assemblies characterized by a first property and a second subset characterized by a second property, wherein the first subset of nanoparticle assemblies are characterized by a first size and the second subset of nanoparticle assemblies are characterized by a second size different from the first size.

In a tenth embodiment, the present invention provides a polymer composite as in any of the above embodiments, the nanoparticle assemblies including a first subset of nanoparticle assemblies characterized by a first property and a second subset characterized by a second property, wherein the first subset of nanoparticle assemblies are characterized as being made from a first material and the second subset of nanoparticle assemblies are characterized as being made from a second material different from the first material.

In an eleventh embodiment, the present invention provides a polymer composite as in any of the above embodiments, the polymer nanocomposite having a first protruding pattern and a second protruding pattern, a trench section extending between the first protruding pattern and the second protruding pattern, the nanoparticle assemblies including a first subset of nanoparticle assemblies characterized by a first property and a second subset characterized by a second property, wherein the first subset of nanoparticle assemblies are selectively migrated in the first protruding pattern and the second protruding pattern, and wherein the second subset of nanoparticle assemblies are selectively migrated in the trench section.

In a twelfth embodiment, the present invention provides a polymer composite as in any of the above embodiments, wherein the free polymer chains and tethered polymers are made from the same material.

In a thirteenth embodiment, the present invention provides a polymer composite as in any of the above embodiments, wherein the free polymer chains and tethered polymers are made from different materials.

In a fourteenth embodiment, the present invention provides a method of making the polymer nanocomposite of any of the above embodiments comprising the steps of: providing a substrate with a nanoparticle assembly-containing film thereon, the nanoparticle assembly-containing film including the nanoparticle assemblies and the free polymer chains; positioning a patterned object having patterns therein on the nanoparticle assembly-containing film; while the nanoparticle assembly-containing film is in contact with the patterned object, annealing the nanoparticle assembly-containing film by a step selected from solvent annealing and temperature-based annealing, said step of annealing causing the nanoparticle assembly-containing film to conform to the patterns of the patterned mask; allowing the nanoparticle assemblies of the nanoparticle assembly-containing film to selectively migrate into the patterns of the patterned mask; removing the patterned object from the nanoparticle assembly-containing film to thereby form a patterned nanoparticle-containing material having one or more patterns, the nanoparticle assemblies being selectively migrated in the patterns of the patterned nanoparticle-containing material.

In a fifteenth embodiment, the present invention provides a method as in any of the above embodiments, wherein the method is a continuous, roll-to-roll process.

In a sixteenth embodiment, the present invention provides a method as in any of the above embodiments, the free polymer chains and the tethered polymers being made from the same material.

In a seventeenth embodiment, the present invention provides a polymer composite having nanoparticle assemblies and free polymer chains, the free polymer chains having a radius of gyration size, each of the nanoparticle assemblies having polymers tethered to a nanoparticle, the free polymer chains and the tethered polymers being made from the same material.

In an eighteenth embodiment, the present invention provides a patterned polymer composite assembly including a substrate having a patterned film thereon, the patterned film including nanoparticle assemblies within a polymer matrix, each of the nanoparticle assemblies having polymers tethered to a nanoparticle, the patterned film including a first pattern, a second pattern, a trench section extending between the first pattern and the second pattern, the first pattern and the second pattern having a higher composition of nanoparticle assemblies than the trench section.

### BRIEF DESCRIPTION OF THE DRAWINGS

Advantages of the present invention will become better understood with regard to the following description, appended claims, and accompanying drawings wherein:

FIG. 1 is a schematic cross-sectional view of a method of making a patterned nanoparticle-containing material according to one or more embodiments of the invention.

FIG. 2 is a schematic view of a method of making a nanoparticle-containing material according to one or more embodiments of the invention.

FIG. 3 is a schematic view of a nanoparticle-containing material according to one or more embodiments of the invention.

### DETAILED DESCRIPTION OF ILLUSTRATIVE EMBODIMENTS

Embodiments of the invention are based, at least in part, on methods of making nanoparticle-containing materials. The nanoparticle-containing materials are made using a plurality of nanoparticle assemblies, each assembly including one or more nanoparticles tethered with polymer chains. The nanoparticle assemblies may be within a polymer film having free polymer chains. The nanoparticle assemblies may be of a larger size than the free polymer chains, such that, upon subjecting the nanoparticle assembly-containing film to a capillary force lithography process, the nanoparticle assemblies advantageously migrate into mesa regions formed in the patterns of a patterned mask.

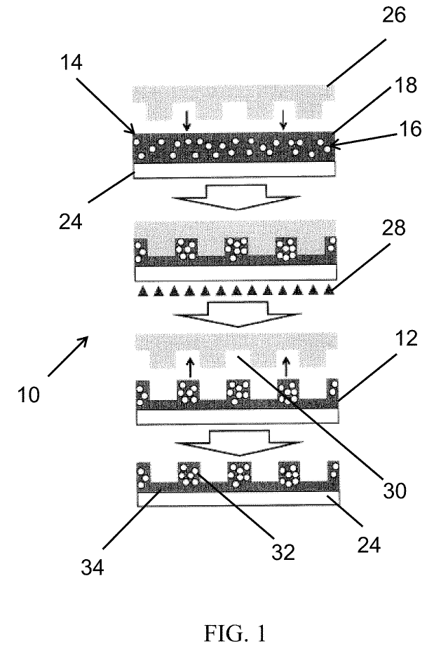

With reference to FIG. 1, the present invention provides a method, generally indicated by the numeral 10, for fabricating a patterned nanoparticle-containing material 12. Method 10, which may be referred to as a capillary force lithography method 10, includes providing or forming a nanoparticle assembly-containing film 14. Film 14 includes a plurality of nanoparticle assemblies 16 within a polymer matrix 18 having free polymer chains. Each nanoparticle assembly 16 includes one or more nanoparticles 22 (FIG. 3) tethered with polymers 20 (FIG. 3).

Nanoparticle assembly-containing film 14 may be provided on a substrate 24. Prior to the introduction of nanoparticle assembly-containing film 14, substrate 24 may be appropriately cleaned so that no contaminants interfere with the adherence of film 14 to substrate 24. The cleaning procedures may include one or more of ultraviolet light exposure, acid treatment, base treatment, plasma treatment, treatment by solvent, or blow-drying by inert gases.

The plurality of nanoparticle assemblies 16 within polymer matrix 18 may be provided in nanoparticle assembly-containing film 14 prior to introduction to substrate 24. Alternatively, polymer matrix 18 may first be provided to substrate 24, followed by introduction of the plurality of nanoparticle assemblies 16 to polymer matrix 18.

Nanoparticle assembly-containing film 14 may be provided on substrate 24 by any suitable method of forming a film, as generally known to those skilled in the art. Examples include flow coating and spin coating

A patterned mask 26 is then provided on nanoparticle assembly-containing film 14. This may include a step of annealing 28 in conjunction therewith. For example, one or more of temperature annealing and solvent-based annealing may be utilized. Where temperature annealing is utilized, the temperature may be brought above the T_{g} of polymer matrix 18 of nanoparticle assembly-containing film 14. Where solvent-based annealing is utilized, as generally known in the art, one or more vaporized solvents interact with film 14 to modify the molecular structure, where this modification allows the film 14 to fill the pattern sections of mask 26.

Annealing step 28 serves to cause nanoparticle assembly-containing film 14 to migrate into the patterns 30 of patterned mask 26, as shown in FIG. 1. This may also be described as patterns 30 of patterned mask 26 confining nanoparticle assembly-containing film 14. As generally understood by those skilled in the art, this may be said to occur by capillary force. Annealing step 28 may be performed by gradually increasing annealing temperature from room temperature to the prescribed temperature higher than T_{g}, in order to avoid detachment of patterned mask 26 from the surface of film 14.

In conjunction with annealing step 28, the plurality of nanoparticle assemblies 16 selectively migrate into the patterns 30 of patterned mask 26. That is, the local composition of the mesas 32 of patterned nanoparticle-containing material 12 is higher in nanoparticle assemblies 16 than the local composition of the trenches 34 of patterned nanoparticle-containing material 12. The selective migration may be referred to as soft-confinement pattern-induced nanoparticle segregation (SCPINS).

This selective migration of nanoparticle assemblies 16 is induced by conformational entropy based on the local perturbations of grafted polymers 20 and the free polymer chains of polymer matrix 18 when film 14 is under confinement by patterned mask 26. This selective migration of nanoparticle assemblies 16 based on conformational entropy may be based on nanoparticle assemblies 16 being sized larger than the free polymer chains of polymer matrix 18, which will be further characterized herein below. This selective migration of nanoparticle assemblies 16 based on conformational entropy may also be based on confining film 14 to achieve very thin trenches 34, which will be further characterized herein below. Where grafted polymers 20 and polymer matrix 18 are chemically dissimilar, this selective migration of nanoparticle assemblies 16 may also be caused by enthalpic interactions between grafted polymers 20 and the free polymer chains of polymer matrix 18.

Following annealing step 28, that is, after driving off solvent in a solvent-annealing process or quenching in a temperature-based annealing process, patterned mask 26 is removed. This leaves a patterned nanoparticle-containing material 12, which may remain present on substrate 24. As will be further described herein, patterned mask 26 may include any suitable pattern therein for imprinting the corresponding topographic features to patterned nanoparticle-containing material 12 by capillary force lithography. Exemplary pattern features include ordered strips and rhombic domain structures. Based on the selective migration of nanoparticle assemblies 16 to the patterns, nanoparticle-containing material 12 may be described as containing nanoparticle domains with well-defined shape, size, and organization.

Embodiments of the present invention may be carried out as an industrialized, continuous process. That is, a method may be suitable for mass production of patterned nanoparticle-containing material 12 by an assembly line. One or more aspects of a continuous process may be disclosed in U.S. Publication No. 20140131912, which is incorporated herein by reference.

A continuous process, which may also be described as a roll-to-roll manufacturing process or roll-to-plate manufacturing process, may include utilizing a roller wheel patterned mask marked with patterns along the circumference thereof. A nanoparticle assembly-containing film may be provided on a substrate. The substrate having a nanoparticle assembly-containing film thereon may be advanced below the roller wheel mask, which rotates as the combination of the substrate and nanoparticle assembly-containing film passes thereunder. The patterns of the roller wheel serve to confine the film, where confinement step proceeds in conjunction with an annealing step, as described herein, to produce a patterned nanoparticle assembly-containing film. A continuous method may also utilize a conveyor belt type structure or other appropriate structure permitting continuous treatment of the film. Embodiments of the continuous method may be described as a one-pass method.

Embodiments of the invention generally provide a method for producing a patterned nanoparticle-containing material, the method comprising one or more of the steps of: providing a substrate with a nanoparticle assembly-containing film thereon; advancing said substrate below a patterned object such that the nanoparticle assembly-containing film contacts the patterned object; while the nanoparticle assembly-containing film is in contact with the patterned object, annealing the nanoparticle assembly-containing film by a step selected from solvent annealing and temperature-based annealing, said step of annealing causing the nanoparticle assembly-containing film to conform to the patterns of the patterned mask, to thereby form a nanoparticle-containing material, wherein the nanoparticle assemblies of nanoparticle assembly-containing film selectively migrate into the pattern features of the nanoparticle-containing material; and advancing the nanoparticle-containing material such that the patterned object no longer contacts the nanoparticle-containing material. A step of providing a substrate with a nanoparticle assembly-containing film thereon may be accomplished by continuously doctor blade coating the nanoparticle assembly-containing film on the substrate. Where the substrate is a flexible substrate, embodiments may utilize a roll-to-roll process. Where the substrate is a hard, inflexible substrate, embodiments may utilize a roll-to-plate process.

Each of nanoparticle assemblies 16, which may referred to as polymer-grafted nanoparticles 16, polymer-tethered nanoparticles 16, or polymer-attached nanoparticles 16, include polymers 20 attached to one or more nanoparticles 22. These attached polymers 20 may be described as macromolecular polymer chains that are attached onto or into nanoparticles 22 by the ends of polymers 20. Exemplary attached polymers 20 include linear homopolymers, linear copolymers, crosslinkable polymers, and highly branched polymers. These polymers 20 may also be described as a polymer brush 20. Any suitable method may be utilized to form nanoparticle assemblies 16. Exemplary methods include grafting-from and grafting-onto, which are generally known by those skilled in the art.

As generally known in the art, nanoparticle assemblies 16 containing polymers 20 attached to one or more nanoparticles 22 may generally retain the properties of both the polymers 20 and the nanoparticles 22. Exemplary properties that may be retained include heat resistance, thermosensitivity, conductivity, optoelectronic properties, plasmatic properties, and magnetic properties.

Nanoparticle assemblies 16 may be characterized by their size. In one or more embodiments, nanoparticle assemblies 16 may have a characteristic lateral dimension of 1 μm or less, in other embodiments, 500 nm or less, and in other embodiments, 50 nm or less. In one or more embodiments, nanoparticle assemblies 16 may have a characteristic lateral dimension in a range of from 20 nm to 1 μm, in other embodiments, from 20 nm to 500 nm, and in other embodiments, from 50 nm to 500 nm. The characteristic lateral dimension may be described as a lateral feature size.

In one or more embodiments, nanoparticle assemblies 16 may have a characteristic height dimension of 1 μm or less, in other embodiments, 200 nm or less, and in other embodiments, 20 nm or less. In one or more embodiments, nanoparticle assemblies 16 may have a characteristic height dimension in a range of from 10 nm to 1 μm, in other embodiments, from 10 nm to 200 nm, and in other embodiments, from 20 nm to 200 nm.

Based on the selective migration of nanoparticle assemblies 16, it may be said that nanoparticle assemblies 16 can be organized in a well-designed fashion (e.g. tetragonal, hexagonal). As disclosed elsewhere herein, the organization of nanoparticle assemblies 16 matches the patterns of patterned mask 26.

Each of nanoparticle assemblies 16 generally includes only one nanoparticle 22. In other embodiments, at least some of the nanoparticle assemblies 16 may include more than one nanoparticle 22, for example, where nanoparticle agglomeration may have occurred when making nanoparticle assemblies 16, or where aggregation nanoparticle assemblies 16 occurs. Though, in certain embodiments, it may be desired to prevent agglomeration or aggregation of nanoparticle assemblies 16 in order to retain individual properties of nanoparticles 22. This prevention of agglomeration or aggregation may be accomplished using relative high grafting density of polymers 20 with long grafted chains. In embodiments, where aggregation of nanoparticle assemblies 16 is desired, relatively low grafting density of polymers 20 may be utilized.

Nanoparticles 22 may be made from a variety of materials. Nanoparticles 22 may be made from metal, metal oxide, quantum dots, clay, fullerene, polymers and semiconducting material. Particular examples may include silver, TiO₂, silica, and SiO₂. In one or more embodiments, the plurality of nanoparticle assemblies 16 may include nanoparticles 22 made from a common material of the above listed materials. In one or more embodiments, the plurality of nanoparticle assemblies 16 may include nanoparticles 22 made from more than one of the above listed materials. That is, in one or more embodiments, the plurality of nanoparticle assemblies 16 may include a first material subset of nanoparticles 22 and a second material subset of nanoparticles 22, up to any suitable number of material subsets.

Nanoparticles 22 may be characterized by their size. In one or more embodiments, nanoparticles 22 may have an average diameter of 100 nm or less, in other embodiments, 50 nm or less, in other embodiments, 25 nm or less, and in other embodiments, 5 nm or less. In one or more embodiments, nanoparticles 22 may have an average diameter in a range of from 1 nm to 100 nm, in other embodiments, in other embodiments, from 1 nm to 25 nm, from 5 nm to 50 nm, and in other embodiments, from 5 nm to 25 nm.

In one or more embodiments, nanoparticles 22 may be spherical. In one or more embodiments, nanoparticles 22 may be non-spherical. In one or more embodiments, particularly embodiments where nanoparticles 22 may be non-spherical, nanoparticles 22 may be characterized as having at least one dimension in a range of from 1 nm to 100 nm.

In one or more embodiments, the plurality of nanoparticle assemblies 16 may include nanoparticles 22 that are commonly sized. In one or more embodiments, the plurality of nanoparticle assemblies 16 may include nanoparticles 22 having different sizes. That is, in one or more embodiments, the plurality of nanoparticle assemblies 16 may include a first-sized subset of nanoparticles 22 and a second-sized subset of nanoparticles 22, up to any suitable number of sized subsets.

In embodiments having more than one subset of nanoparticles 22, whether material subsets, sized subsets, or both material subsets and sized subsets, these subsets may be designed to accomplish a particular design of nanoparticle-containing material 12. In one or more embodiments, a first subset of nanoparticle assemblies 16 containing a first subset of nanoparticles 22 may be selectively migrated into the patterns and a second subset of nanoparticle assemblies 16 containing a second subset of nanoparticles 22 may be homogenously distributed among nanoparticle-containing material 12. That is, a first subset may be sized as to selectively migrate into patterns while a second subset is sized as to not selectively migrate into patterns. This series of nanoparticle subsets may be particularly accomplished in embodiments where a terrace patterned mold 36 is utilized, which will be further described herein. In one or more embodiments, a first subset of nanoparticle assemblies 16 containing a first subset of nanoparticles 22 may be selectively migrated into the patterned mesas and a second subset of nanoparticle assemblies 16 containing a second subset of nanoparticles 22 may be selectively migrated into the patterned thin trenches. That is, the two subsets may form distinctive domains based on the patterns on the mask.

Nanoparticles 22 may be selected for their particular optoelectronic, plasmatic, and magnetic properties. These properties may be based on the particular size of nanoparticles 22. As described above, nanoparticle assemblies 16 containing nanoparticles 22 may retain the advantageous properties of the individual nanoparticles 22.

Nanoparticle assemblies 16 include one or more nanoparticles 22 grafted with polymers 20. The attached polymers 20 may either be in a solvated state, where the tethered polymer layer consists of polymer and solvent, or in a melt state, where the tethered chains completely fill up the space available.

Polymers 20 may be made from a variety of polymeric materials. Exemplary polymeric materials for polymers 20 include polystyrene (PS), poly(methyl methacrylate) (PMMA), polyvinylpyrrolidone (PVP), and PS-b-PMMA diblock copolymer. In one or more embodiments, the polymers 20 may be made from a common material of the above listed materials. In one or more embodiments, polymers 20 may be made from more than one of the above listed materials. That is, in one or more embodiments, a plurality of nanoparticle assemblies 16 may include a first material subset of polymers 20 and a second material subset of polymers 20, up to any suitable number of material subsets.

As shown in FIG. 3, polymers 20 may be characterized by thickness. This thickness may be calculated from the outer surface of nanoparticle 20 to the outer surface of the grafted polymers 22. FIG. 3 shows h_{confine}, which may be characterized as the thickness from the outer surface of nanoparticle 20 to the outer surface of the grafted polymers 22 when a nanoparticle assembly 16 is confined within trench 34. Nanoparticle assemblies may also be characterized by h_{brush}, which may be characterized as the thickness from the outer surface of nanoparticle 20 to the outer surface of the grafted polymers 22 when a nanoparticle assembly 16 is not confined.

In one or more embodiments, polymers 20 may have a thickness of h_{confine} of 5 nm or less, in other embodiments, 20 nm or less, and in other embodiments, 50 nm or less. In one or more embodiments, polymers 20 may have a thickness of h_{confine} of 5 nm or more, in other embodiments, 20 nm or more, and in other embodiments, 50 nm or more.

In one or more embodiments, polymers 20 may have a thickness of h_{brush} of 5 nm or less, in other embodiments, 20 nm or less, and in other embodiments, 50 nm or less. In one or more embodiments, polymers 20 may have a thickness of h_{brush} of 5 nm or more, in other embodiments, 20 nm or more, and in other embodiments, 50 nm or more. In one or more embodiments, polymers 20 may have a thickness of h_{brush} of 12.8 nm or approximate thereto.

The entropy loss of a patterned nanoparticle-containing material 12 may be characterized as a function of the degree of entropic confinement. Entropic confinement may be defined as a ratio of h_{brush}/h_{confine}, with higher ratios indicating greater confinement. In one or more embodiments, h_{brush}/h_{confine} may be a ratio of 1 or less. In one or more embodiments, h_{brush}/h_{confine} may be a ratio in a range of from 0.6 to 1, and in other embodiments, from 0.8 to 1. In one or more embodiments, h_{brush}/h_{confine} may be a ratio of more than 1. In one or more embodiments, h_{brush}/h_{confine} may be a ratio in a range of from 1 to 1.4, in other embodiments, from 1 to 1.5, and in other embodiments, from 1 to 2.2. In one or more embodiments, h_{brush}/h_{confine} may be a ratio of 0.6 or approximate thereto. In one or more embodiments, h_{brush}/h_{confine} may be a ratio of 0.8 or approximate thereto. In one or more embodiments, h_{brush}/h_{confine} may be a ratio of 1.4 or approximate thereto. In one or more embodiments, h_{brush}/h_{confine} may be a ratio of 2.2 or approximate thereto.

Polymers 20 may be characterized by grafting density. In one or more embodiments, polymers 20 may have a grafting density of 1 chain/nm² or less, and in other embodiments, 5 chains/nm² or less. In one or more embodiments, polymers 20 may have a grafting density in a range of from 0.7 chains/nm² to 5 chains/nm², and in other embodiments, from 1 chain/nm² to 5 chains/nm². In one or more embodiments, polymers 20 may have a grafting density of 0.7 chains/nm² or approximate thereto.

Polymers 20 may be characterized by number average molar mass (Mₙ). In one or more embodiments, polymers 20 may have a number average molar mass of 3 kg/mol or less, in other embodiments, 20 kg/mol or less, in other embodiments, 100 kg/mol or less, and in other embodiments, 500 kg/mol or less. In one or more embodiments, polymers 20 may have a number average molar mass of 5 kg/mol or more, in other embodiments, 20 kg/mol or more, and in other embodiments, 500 kg/mol or more. In one or more embodiments, polymers 20 may have a number average molar mass of 11.5 kg/mol or approximate thereto.

Polymers 20 may be characterized by degree of polymerization. In one or more embodiments, polymers 20 may have a degree of polymerization of 10 or less, in other embodiments, 200 or less, and in other embodiments, 1000 or less. In one or more embodiments, polymers 20 may have a degree of polymerization of 10 or more, in other embodiments, 200 or more, and in other embodiments, 1000 or more. In one or more embodiments, polymers 20 may have a degree of polymerization of 110 or approximate thereto.

Polymers 20 may be characterized by polydispersity index (PDI). In one or more embodiments, polymers 20 may have a PDI in the range from 1 to 1.5, in other embodiments, from 1.5 to 2, in other embodiments, from 1 to 2, in other embodiments, 1 or more, and in other embodiments, 2 or more.

With respect to any of the above properties, in one or more embodiments, polymers 20 may have one or more common properties. In one or more embodiments, polymers 20 may have one or more different properties. That is, in one or more embodiments, a plurality of nanoparticle assemblies 16 may include a first subset of polymers 20 and a second subset of polymers 20, up to any suitable number of polymer subsets.

Nanoparticle assembly-containing film 14, which may also be described as a polymer nanocomposite assembly 14, includes a polymer matrix 18 having the plurality of nanoparticle assemblies 16 therein. Polymer matrix 18 may be made from a variety of polymeric materials. Polymer matrix 18 may be made from polystyrene (PS), poly(methyl methacrylate) (PMMA), polyvinylpyrrolidone (PVP), PS-b-PMMA diblock copolymer, and combinations thereof. Polymer matrix 18 may be one or more of homopolymers, copolymers, star polymers, branched polymers, and crosslinkable polymers.

Nanoparticle assembly-containing film 14 may be characterized as a thin film configuration having an out-of-plane film dimension that is significantly smaller than the in-plane dimension. In one or more embodiments, the in-plane dimension is at least 10³ times greater, in other embodiments, at least 10⁴ greater, and in other embodiments, at least 10⁶ greater than the out-of-plane film dimension.

In one or more embodiments, the initial film thickness of nanoparticle assembly-containing film 14 when on substrate 24 is 300 nm or less, in other embodiments, 200 nm or less, and in other embodiments, 100 nm or less. Nanoparticle assembly-containing film 14 may be characterized as having a sufficient thickness to fill all of the pattern voids of patterned mask 26, while also maintaining a residual layer on substrate 24 after the patterning process as to form trenches 34.

In one or more embodiments, attached polymers 20 and polymer matrix 18 may be made from the same material, which may be referred to as ‘athermal.’ In these embodiments, the selective migration of nanoparticle assemblies 16 may be based primarily on conformational entropy, that is, with minimal impact of enthalpic interactions. In one or more embodiments, attached polymers 20 and polymer matrix 18 may be made from the chemically dissimilar materials. In these embodiments, the selective migration of nanoparticle assemblies 16 may also be caused by enthalpic interactions between grafted polymers 20 and the free polymer chains of polymer matrix 18.

Polymer matrix 18 is composed of free polymer chains, which may be characterized by their root-mean-square radius of gyration R_{g} (or simply radius of gyration). In one or more embodiments, free polymer chains of polymer matrix 18 may have a radius of gyration of 2 nm or less, in other embodiments, 10 nm or less, and in other embodiments, 50 nm or less. In one or more embodiments, free polymer chains of polymer matrix 18 may have a radius of gyration of 2 nm or more, in other embodiments, 10 nm or more, and in other embodiments, 50 nm or more. In one or more embodiments, free polymer chains of polymer matrix 18 may have a radius of gyration of 1.6 nm or approximate thereto.

Nanoparticle assemblies-containing material 12 may be characterized by a composition of nanoparticle assemblies 16. The composition of nanoparticle assemblies 16 is defined as the weight ratio of nanoparticle assemblies 16 and polymer matrix 18. That is, 20 parts nanoparticle assemblies 16 and 100 parts polymer matrix 18 would be characterized as 20%. In one or more embodiments, nanoparticle assemblies-containing material 12 has a composition of nanoparticle assemblies 16 of 10 wt. % or more, in other embodiments, 20 wt. % or more, in other embodiments, 40 wt. % or more, in other embodiments, 50 wt. % or more, in other embodiments, 80 wt. % or more, and in other embodiments, 90 wt. % or more, with respect to polymer matrix 18. In one or more embodiments, nanoparticle assemblies-containing material 12 has a composition of nanoparticle assemblies 16 of 100 wt. % or less, in other embodiments, 80 wt. % or less, in other embodiments, 60 wt. % or less, in other embodiments, 50 wt. % or less, in other embodiments, 40 wt. % or less, and in other embodiments, 30 wt. % or less, with respect to polymer matrix 18.

Polymer matrix 18 may be characterized by molecular weight of free polymer chains. If the molecular weight of the free polymer chains is too large, particularly when compared to the size of the grafted polymers 20, the selective segregation of nanoparticle assemblies 16 into mesas 32 may be disrupted. In one or more embodiments, free polymer chains of polymer matrix 18 have a molecular weight of 3 kg/mol or less, in other embodiments, 4 kg/mol or less, and in other embodiments, 6 kg/mol or less.

As mentioned above, the selective migration of nanoparticle assemblies 16 into the pattern areas based on conformational entropy may be based on nanoparticle assemblies 16 being sized larger than the free polymer chains of polymer matrix 18. In one or more embodiments, h_{brush} of the tethered polymers of the nanoparticle assemblies is greater than the radius of gyration of the free polymer chains. In one or more embodiments, h_{brush} of the tethered polymers of the nanoparticle assemblies is at least 1.5 times greater than, in other embodiments, at least two times greater than, and in other embodiments, at least three times greater than, the radius of gyration of the free polymer chains.

In one or more embodiments, h_{brush} of the tethered polymers of the nanoparticle assemblies may be less than the radius of gyration of the free polymer chains. In these embodiments, the size of nanoparticles 20 allows the size of nanoparticle assemblies 16 to be greater than the radius of gyration of the free polymer chains.

In one or more embodiments, the radius of nanoparticles 20 is greater than the radius of gyration of the free polymer chains. In one or more embodiments, the radius of nanoparticles 20 at least 1.5 times greater than, in other embodiments, at least two times greater than, and in other embodiments, at least three times greater than, the radius of gyration of the free polymer chains.

In one or more embodiments, nanoparticle assemblies 16 may be characterized by a size from the center of nanoparticle 20 to the outer surface of the grafted polymers 22, when nanoparticle assembly 16 is not confined. This may be referred to as a radius of nanoparticle assembly 16. In one or more embodiments, the radius of nanoparticle assemblies 16 is greater than the radius of gyration of the free polymer chains. In one or more embodiments, the radius of nanoparticle assemblies 16 is at least 1.5 times greater than, in other embodiments, at least two times greater than, and in other embodiments, at least three times greater than, the radius of gyration of the free polymer chains.

Patterned nanoparticle-containing material 12, which may be referred to as a patterned polymer nanocomposite 12, includes one or more pattern sections 32, which may also be referred to as mesas 32 or protruding patterns 32, and trenches 34 extending between the pattern sections 32. Patterns 32 have nanoparticle assemblies 16 selectively migrated therein and therefore have a higher composition of nanoparticle assemblies 16 than trenches 34. In one or more embodiments, the dispersion of nanoparticles is maintained in patterned nanoparticle-containing material 12 after the patterning processes without aggregation or crystallization. Nanoparticle assemblies 16 may achieve different morphologies depending on the relative size of grafted polymer 20 to free polymer chains of polymer matrix 18, and the grafting density of grafted polymer 20. Exemplary morphologies include well-dispersion, small clusters, and phase-separation.

Patterned nanoparticle-containing material 12 may be characterized by the thickness of patterns 32 and trenches 34. In one or more embodiments, the thickness of patterns 32 (h₁ in FIG. 3) is equal to or greater than, in other embodiments, is at least 1.5 times greater than, in other embodiments, at least two times greater, in other embodiments, at least 2.5 times greater, and in other embodiments, at least three times greater than the thickness of trenches 34 (h₂ in FIG. 3). In one or more embodiments, the thickness of patterns 32 is from 1.5 times to three times greater than, and in other embodiments, from two times to three times greater than the thickness of trenches 34.

In one or more embodiments, the thickness of patterns 32 (h₁ in FIG. 3) is 50 nm or more, in other embodiments, 100 nm or more, and in other embodiments, 200 nm or more. In one or more embodiments, the thickness of trenches 34 (h₂ in FIG. 3) is 100 nm or less, in other embodiments, 50 nm or less, and in other embodiments, 20 nm or less. Patterned nanoparticle-containing material 12 may also be characterized by the difference (Δh) between h₁ and h₂. In one or more embodiments, the difference (Δh) between h₁ and h₂ is 20 nm or more, in other embodiments, 50 nm or more, and in other embodiments, 100 nm or more

Patterned nanoparticle-containing material 12 may be characterized by the composition of nanoparticle assemblies 16 within patterns 32 and trenches 34. The composition difference between mesas 32 and trenches 34 of nanoparticle assemblies 16 may be characterized by a partition coefficient, K. The partition coefficient, K, may be calculated as the ratio of particle concentration in trenches 34 to particle concentration in mesas 32. This may be given as ρ₂/ρ₁ (FIG. 3). In one or more embodiments, the partition coefficient, K, may be 0, or approximate thereto. In one or more embodiments, the partition coefficient, K, may be 1, or approximate thereto. In one or more embodiments, the partition coefficient, K, may be less than 1, in other embodiments, less than 0.5. In one or more embodiments, the partition coefficient, K, may be 2.5, or approximate thereto.

From calculated partition coefficients, the resultant free energy change upon confinement with patterned mask 26 can be estimated by ΔF=−kT ln K for embodiments with minimal enthalpic interactions, where ΔF represents the differential free energy of the blend system as one nanoparticle assembly 16 is relocated from mesa 32 to trench 34, k is the Boltzmann constant, and T is the absolute temperature. ΔF accounts for the conformational entropy gain and translational entropy loss when nanoparticle assemblies 16 are selectively sequestered into mesas 32.

It has been further realized that stronger segregation of nanoparticle assemblies 16 in mesas 32 versus in trenches 34 may be accomplished by one or more other properties. For example, stronger segregation of nanoparticle assemblies 16 in mesas 32 versus in trenches 34 may be accomplished with polymer matrix 18 having free polymer chains of smaller radius of gyration. In one or more embodiments, free polymer chains with a molecular weight of 2.8 kg/mol achieves stronger segregation of nanoparticle assemblies 16 in mesas 32 versus in trenches 34 than free polymer chains with a molecular weight of 16 kg/mol. Also, stronger segregation of nanoparticle assemblies 16 in mesas 32 versus in trenches 34 may be accomplished using larger difference (Δh) between h₁ and h₂. This generally increases the level of confinement on nanoparticle assembly-containing film 14. The term stronger segregation may also be characterized as more concentrated distribution of the nanoparticle assemblies in the mesas 32.

Patterned nanoparticle-containing material 12 may be characterized by an additional characteristic domain size, where the characteristic domain size is a designed dimension resulting from the combination of nanoparticle assembly 16 loading composition and the level of confinement during a patterning process. Examples of characteristic domain size include width of patterns 32, length of patterns 32, and periodic spacing between patterns 32. In one or more embodiments, one or more of these sizes may be characterized by a size of 10 nm or more.

Patterns 32 may take any shape, based on the patterns of mask 26. Exemplary shapes for patterns 32 include periodic squares, rhombic domains, and spherical domains. In one or more embodiments, patterns 32 may include one or more of these shapes.

Patterned nanoparticle-containing material 12 may be utilized in a variety of applications. Exemplary applications where patterned nanoparticle-containing material 12 may be utilized include photonics, electrical devices, biosensors, magnetic storage, integrated circuit fabrication, flat-panel display, solar cells, diagnostic testing, nanoelectronics, and nanoplasmonics.

Patterned mask 26, with recessed and protruding patterns, may be an elastomer mask that is fabricated by curing against a complementary structure. The complementary structure, or relief structure, includes the pattern that is imparted to patterned mask 26 upon curing. The complementary structure can be selected from virtually any substrate providing a geometry of pattern segments that can be imparted to an elastomer coated thereon. The complementary structure may be prepared on a silicon substrate by photolithography or electron-beam etching. An example of the complementary structure is the polycarbonate layer from commercial DVD or CD disks. An example of the elastomer used for patterned mask is PDMS. Patterned mask 26 may be soft molded to provide conformal contact with film 14. One or more aspects of a patterned mask may be disclosed in U.S. Publication No. 20140131912, which is incorporated herein by reference.

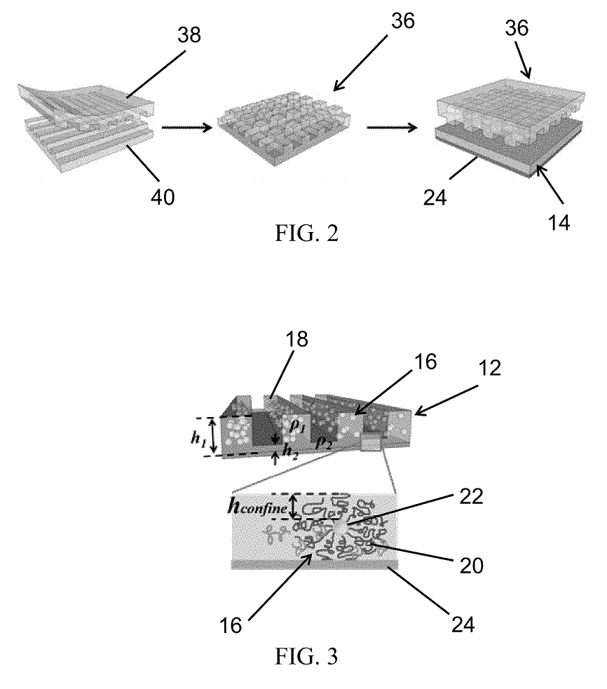

In one or more embodiments, patterned mask 26 may be fabricated by dual imprinting, as shown in FIG. 2. A partially cured channel patterned elastomer layer 38 may be placed on another fully cured channel patterned mold 40. The placement of layer 38 may be at a particular angle, for example 90°, with respect to the mold 40. Upon placement of layer 38, an additional thermal curing step may be performed to accomplish terraced patterned mask 36, though other patterns may be realized. The terraced patterned mask 36 may then be utilized in a patterning process as disclosed herein.

Substrate 24 may be chosen from virtually any material or product that benefits from being covered with a patterned nanoparticle-containing material. Suitable substrates 24 include glass, quartz, metal, and polymer substrates. Substrate 24 may be a silicon substrate. Polymer substrates may include homopolymers, polymer blends, and block copolymers. Exemplary flexible substrates, such as may be used in a roll-to-roll process, include polyimide (PI) and poly (ethylene teraphthalate) (PET). Exemplary hard substrates, such as may be used in a roll-to-plate process, include silicon and quartz.

Methods and assemblies of the present invention may offer one or more advantages over the existing art. For example, a method may offer one or more of lower-cost, higher-throughput, high resolution, and pattern fidelity. The method may also be utilized with a variety of polymer matrix 18 and nanoparticle 22 materials. Therefore, embodiments of the invention may be capable of achieving particular optoelectronic, magnetic, or mechanical properties with the appropriate choice of polymer matrix 18 and nanoparticle 22 materials. Moreover, the composition of nanoparticle assemblies 16 in patterns 32 may be precisely tuned by changing the initial loading of nanoparticle assemblies 16 in films 14. Thus, the properties (e.g. refractive index, dielectric constant) of patterned nanoparticle-containing material 12 may be tuned accordingly to meet the targeted property requirement.

### EXAMPLES

### Example 1

Materials:

Thiol-polystyrene (PS-SH) grafted gold nanoparticles (AuPS) were synthesized by phase transfer reduction of [AuCl⁴] in the presence of thiol ligands. The average radius of the gold core was about 1.2 nm. PS grafting density was 0.7/nm². The molecular weight of grafted PS chains was 11.5 kg/mol. Poly (methyl methacrylate) (PMMA, M_{n,PMMA}=3.1 kg/mol, polydispersity=1.09) were purchased from Polymer Source Inc. and used as obtained.

Mask Fabrication:

Topographically patterned cross-linked poly (dimethyl siloxane) (PDMS) elastomer mold was made using Slygard 184 with a curing agent to base ratio of 1:20. After mixing and degassing, PDMS was cured on a channel patterned polycarbonate substrate from a commercial DVD disk (DVD, pitch λ=750 nm, amplitude A=120 nm) at 120° C. for 6 h to generate a channel patterned PDMS mold. Alternatively, a partially cured channel patterned PDMS was applied on another fully cured channel patterned PDMS to fabricate a cross-hatch lattice patterned elastomer mold.

Film:

PMMA solutions (3 wt. % in toluene) were mixed with appropriate amount of AuPS nanoparticles to result in solutions with 20 to 100 wt. % AuPS relative to polymer weight. The NP-polymer solution was flow coated into thin films with thickness of about 90 nm on silicon substrates followed by vacuum oven annealing at 55° C. for 6 h to remove residual solvent. Capillary force lithography with patterned PDMS mold was conducted at 180° C. for 1 h. After annealing, the PDMS layer was removed for characterizations.

Patterned Nanocomposite:

The polymer nanocomposite was prepared with gold nanoparticle assemblies in chemically dissimilar polymer thin film. Top-view TEM images of the patterned AuPS/PMMA blend thin films were obtained. The imprinted pattern pitch was 750 nm and step height was 120 nm. The alternative dark and light regions corresponded to imprinted mesas and trenches, respectively. The loading fraction of AuPS nanoparticles was 100% relative to PMMA weight (i.e. the weight ratio of AuPS nanoparticle and PMMA was 1:1). As seen in the magnified image, after imprinting, all the AuPS nanoparticles were located in the mesas with good dispersion. In this case, the AuPS domain width was the same as mesa width (about 375 nm).

The effect of AuPS nanoparticle loading fraction on the patterned nanoparticle domain structures in AuPS/PMMA blend films was determined. The loading fraction of AuPS nanoparticles was varied at 20%, 40%, and 50% relative to PMMA weight. Top-view TEM images with color scales (i.e. dark, grey, and light) were obtained. The grey-light contrast was observed for the imprinted mesa-valley height difference, and the dark-grey contrast was observed for the phase separated structures of AuPS-rich phase (dark) and PMMA-rich phase (grey). The imprinted pattern pitch was 750 nm and step height was 120 nm. It was seen that in all three AuPS compositions, the AuPS-rich domains formed long strips in channel direction and segregated at one side of the mesas. The characteristic dimensions of the nanoparticle strips included a well-defined inter-strip spacing determined by pattern confinement and a nanoparticle domain width determined by nanoparticle loading (i.e. the domain width increased with increasing AuPS loading).

A 3D AFM image line profile was obtained for a cross-hatch lattice patterned AuPS/PMMA blend thin film. The imprinted pattern pitch was 750 nm and step height was about 60 nm from bottom to intermediate height and was about 60 nm from intermediate stage to intersection plateaus. The loading fraction of AuPS nanoparticles was 30%. Top-view TEM images with color scales (i.e. dark, grey, and light) were obtained. The grey-light pattern contrast was from the height difference of imprinted valleys and intermediate height regions. These regions are composed of PMMA-rich phase. The dark region at each intersection corresponded to both the AuPS-rich domain and the topographic plateau. It was seen that the nanoparticle domains were exclusively distributed at the plateaus in a tetragonal organization fashion while the random dispersion of nanoparticles was retained within the AuPS-rich domains.

### Example 2

Materials:

Polystyrene (PS) with different molecular masses were purchased from Polymer Source Inc. and used as obtained (PS 3k, M_{n,PS}=2.8 kg/mol, PDI=1.09; PS 4k, M_{n,PS}=4.8 kg/mol, PDI=1.07; PS 6k, M_{n,PS}=6.1 kg/mol, PDI=1.05; PS 16k, M_{n,PS}=16 kg/mol, PDI=1.03; PS 160k, M_{n,PS}=160 kg/mol, PDI=1.05; PS 360k, M_{n,PS}=360 kg/mol, PDI=1.09.) Thiol-polystyrene (PS-SH) grafted gold nanoparticles (AuPS) were synthesized by phase transfer reduction of [AuCl⁴] in the presence of thiol ligands. The average radius of gold core R₀ was 1.2±0.4 nm. The grafted PS molecular mass was M_{n,PS,grafted}=11.5 kg/mol and the grafting density (σ) was 0.7/nm². Upon vacuum oven annealing at 180° C. for 16 h, AuPS nanoparticles experienced subtle size increase to R₀ of 1.3±0.5 nm due to the thermal instability of thiol-Au bond. The average radius of SiO₂ core was R₀ of 7.7±2.1 nm, grafted with PS chains with M_{n,PS}=54 kg/mol at grafting density of 0.57/nm². The PS-g-SiO₂ particles were synthesized by surface-initiated atom transfer radical polymerization using known procedures. PS solutions (3% by mass in toluene) were pre-mixed with appropriate amounts of polymer-grafted nanoparticles (PGNP's) (mass ratio of AuPS to PS was 30% to 200%) and flow coated into thin films of thickness h of about 80 to 150 nm on silicon substrates. The film thicknesses were determined by interferometer (F-20 UV Thin Film Analyzer, Filmetrics, Inc.).

Cross-linked poly(dimethylsiloxane) (PDMS) elastomer layers (thickness of about 0.5 mm, elastomer mass:curing agent mass=20:1) were made by curing at 120° C. for 6 h on smooth glass slides, commercial digital video discs (pitch λ about 750 nm, height difference Δh about 120 nm), or electronic-circuit-like patterned silicon templates. The smooth or patterned PDMS layers served as confinement during thermal annealing. After annealing for certain time periods, the PDMS layer was removed for characterization. Nanoparticles distributions were characterized with a JEOL JEM-1230 transmission electron microscope (TEM) at 200 kV. Specimens for TEM were prepared by pre-coating a thin layer (about 10 nm) of aqueous poly(4-styrenesulfonic acid) (PSS; Sigma-Aldrich) solution on to the substrates prior to coating the blend films, annealing the multilayer films, and then floating the films by immersing into distilled water followed by transferring to copper grids. Surface topography of the blend films was imaged using a Dimension Icon atomic force microscope (AFM) (Bruker AXS) in tapping mode.

The entropy-driven segregation of polymer-grafted nanoparticles using model thin films of PGNP/polymer blends with well-controlled molecular parameters was investigated. In particular, polystyrene-grafted gold nanoparticles (denoted as AuPS) embedded in polystyrene (PS) thin film matrices having a series of chain lengths were utilized.

Patterned Nanocomposite:

To elicit nanoparticle migration, the homogeneous as-cast AuPS/PS blend films were thermally annealed for 10 min at 180° C., which was significantly higher than the glass-transition temperature of PS (T_{g, PS} of about 75° C. to 105° C.), confined via a channel-patterned elastomer (PDMS) capping layer. During this process, capillarity induced rapid mold filling and generated patterned topography composed of alternating mesas and trenches with a pitch, λ=(752±6) nm and a step height, Δh=(119±1) nm, as seen in an obtained 3D AFM height image. For AuPS/PS blend films with an initial thickness h of about 80 nm, channel-pattern confined annealing generated a modulated film topography characterized with a mesa thickness h₁ of about 140 nm, and a trench thickness h₂ of about 20 nm. The blend films were sufficiently thick to fill the pattern cavity completely and there was a residual layer after the capillary force lithography process.

The distributions of AuPS particles in PS 3k (M_{n,PS,matrix}=2.8 kg/mol) matrix were characterized by top-view TEM micrographs. Exclusive AuPS segregation in mesas (dark strips in obtained TEM) was generated. A pertinent feature of the selective AuPS segregation is that the formation of particle-rich zones occurs while the blend system maintains overall miscibility due to the wettability of grafted PS layer by matrix PS 3k chains, which was discerned from the absence of particle aggregation in both particle-rich and particle-depleted zones.

The preferential segregation of PGNPs in ‘athermal’ blends is believed to be influenced by the degree of entropic confinement of i) brush chains in trenches (h_{brush} h_{confine}), ii) free polymer chains trapped between gold cores and trench walls (2R_{g,PS}/h_{confine},) and iii) free polymer chains confined between top and bottom trench walls (2R_{g,PS}/h₂). Variation of the free polymer chain size R_{g,PS} and the initial blend film thickness h, which controls the trench thickness h₂, allows tuning AuPS segregation in the patterned mesa-trench regions. Therefore the molecular mass of the matrix PS chains was systematically varied from 2.8 kg/mol to 360 kg/mol and the initial film thickness was varied from 85 to 140 nm. Uniform distribution of AuPS particles was maintained in all PS matrices upon thermal annealing without patterned confinement. The process of selective segregation of nanoparticles was induced by channel-pattern confined annealing at 180° C. for 1 h, which was sufficient to generate thermodynamically stable structures. With increasing PS matrix molecular mass at the same initial film thickness (h of about 85 nm), the selective segregation of PGNP's in mesas was progressively suppressed. This changeover may be explained by a more pronounced conformational entropy loss of the free polymer chains with increasing chain length via the increase in 2R_{g,PS}/h_{confine} and 2R_{g,PS}/h₂. Simultaneously, there was a gradual reduction in entropic confinement of the grafted chains manifested in a decrease of h_{brush} in the mixture with longer PS matrix chains. Separately, more uniform AuPS distribution was generated by increasing initial film thickness h while the matrix molecular mass was constant. In this case, the entropic confinement effect for AuPS particles was gradually reduced at trenches and thus more uniform distribution was induced.

The soft confinement pattern-induced nanoparticle segregation (SCPINS) phenomenon was further quantified by the partition coefficient K. The partition coefficient is evaluated by the concentration ratio of AuPS particles, ρ₂/ρ₁, where ρ₁ and ρ₂ are particle concentrations in mesas and trenches, respectively. The dependence of K on the entropic confinement degree for grafted polymer chains (h_{brush}/h_{confine}) by varying initial film thickness h in PS matrices with different molecular masses was determined. With marginal entropic confinement (i.e., h_{brush}/h_{confine}→0), the AuPS distributions in all PS matrices were homogeneous (K=1). Strong confinement (i.e., h_{brush}/h_{confine}>1), in contrast, generated complete AuPS segregation at mesas (K→0) in low molecular mass PS matrices, as the entropic penalty associated with polymer brush chains notably outweighed that of free chains when located in trenches. The transition gradient of K between weak and strong confinement regimes is mediated by the relative size of grafted and free polymer chains (h_{brush}/2R_{g,PS}), where a milder transition was observed in longer PS matrix chains. When the grafted and free polymer chains were of comparable size (i.e., h_{brush}/2R_{g,PS} of about 1), the partition coefficient was constant (K=1) and independent of the entropic confinement degree, indicating an equivalent conformational entropy loss for both components. In a reversal of the above observations, as the molecular mass of free PS chains further increased, the AuPS particles became more concentrated in the trenches (K>1), while the free polymer chains segregated into the mesas due to the associated more significant entropic penalty under confinement. It should be noted, however, that in the case of ultrathin trench confinement (i.e., h₂ was approximately 2R_{g,PS}), only partial depletion of matrix PS chains was observed as the mobility of free polymer chains was significantly suppressed beyond practical equilibration times.

From partition coefficients of the channel-patterned AuPS/PS blend films, the resultant free energy change can be estimated by ΔF=−kT ln K, as provided above. ΔF represents the differential free energy of the blend system as one individual AuPS particle is relocated from mesa to trench. Since the enthalpic interactions are largely screened, the free energy change corresponded to the overall entropic penalty. For example, ΔF accounts for the conformational entropy gain and translational entropy loss when particles were selectively sequestered into mesas in low molecular mass polymer matrices. When the confinement degree was relatively weak (h_{brush}/h_{confine}<0.9), only marginal free energy change (|ΔF|≦kT) is induced. As the confinement became moderate (1<h_{brush}/h_{confine}<1.5), a drastic increase in |ΔF| was induced in low molecular mass PS matrices, resulting in stronger segregation of AuPS particles in mesas versus in trenches. The scaling behaviors of free energy change for PGNP's in different polymer matrices under various confinement conditions was determined. To further confirm that the selective particle segregation was driven by entropic confinement effect, the variation of ΔF in PS 3k matrix (h about 85 nm) was studied under soft channel-patterned confinement with varied pattern height difference (Δh). The corresponding TEM micrographs were obtained, where a more uniform AuPS distribution in mesas versus trenches is induced by reducing Δh. The transition of ΔF by reducing Δh overlapped similarly with that by increased initial film thickness h. This universal behavior of the confinement induced segregation of PGNP's confirmed that the equilibrium characteristics of the partitioning system (i.e., K, ΔF) depend only on the relative entropic confinement degree (h_{brush}/h_{confine}), rather than the absolute values of individual parameters.

The example was extended to other ‘athermal’ PGNP/polymer blend systems and more complex topographic patterns to illustrate the generality and versatility of the method. Selective segregation of PS-g-SiO₂ particles (R₀=7.7±2.1 nm, M_{n,PS}=54 kg/mol, σ=0.57/nm²) in PS 3k films (h about 90 nm) was achieved upon channel-pattern confined thermal annealing. The TEM image revealed highly selective concentration of PS-g-SiO₂ particles in mesas due to the entropic confinement effect (h_{brush}/h_{confine} about 3), as well as superlattice formation of particles within mesas. Since this entropy-driven segregation process only relied on the relative confinement on the grafted and matrix polymers, this method is envisioned to be universal to different particle systems. Application of this method to form more complex patterned PGNP domain structures was further demonstrated by using patterned confinement with different shapes and confinement dimensions. A AFM 3D height image was obtained to show the topography of lattice patterned 30% AuPS/PS 3k blend films (h about 85 nm, λ about 750 nm) composed of periodic intersecting rhombic mesas (about 145 nm), intermediate channels (about 85 nm), and trenches (about 25 nm), with confinement from weak to strong. The corresponding variation in AuPS distributions was seen in TEM micrographs, where the nanoparticles were uniformly distributed between rhombic mesas and channels with identical concentration (i.e., particle number proportional to local film thickness), while completely depleted from the trenches. Complete AuPS nanoparticle segregation within thick mesas when confined by an electronic circuit shaped topographically patterned elastomer capping layer was obtained, which demonstrates potential for nanoelectronics and nanoplasmonics.

### Example 3

Materials:

Blend thin films composed of PS-g-TiO₂ nanoparticles in polystyrene (PS) matrix and PMMA-g-TiO₂ nanoparticles in PMMA matrix were studied. PS (M_{n,PS}=2.8 kg/mol, PDI=1.09) and PMMA (M_{n,PMMA}=3.1 kg/mol, polydispersity=1.09) were purchased from Polymer Source Inc. and used as obtained. The average diameter of the bare TiO₂ particle core is D₀=24±1 nm with a grafting density σ of about 0.61 chains/nm². The number average molecular mass of the grafted PS ligands is M_{n,PS}=15 kg/mol. The TiO₂ particles were synthesized using a ‘grafting to’ approach as generally known. The solvent used in this study was toluene, purchased originally from Fisher Scientific (Certified ACS; ≧99.5%). Poly (4-styrenesulfonic acid) (PSS), 18 wt % solution in water was purchased from Aldrich Chemistry and dissolved in isopropyl alcohol (IPA) to make 1 wt. % PSS solution for the preparation of TEM samples.

PS or PMMA solutions (3% by mass in toluene) were pre-mixed with desired amount of PS-g-TiO₂ or PMMA-g-TiO₂ nanoparticles, respectively, where weight ratio of nanoparticles to polymer was 20% and 10%, respectively. The mixed solutions were flow-coated to result in thin films of thickness of about 85 nm on cleaned silicon substrates pre-treated with UVO exposure. The PDMS molds were prepared by casting against rigid pattern masters and thermally cured to form relief mold features fully replicated from master. Cross-linked poly(dimethylsiloxane) (PDMS) stamp with a thickness of 0.5 mm was cured by a mixture of curing agent/uncured elastomer at a weight ratio of 1:20 at 120° C. for 6 hours on commercially available digital video disc template (pitch of about 750 nm, height difference Δh of about 120 nm). During the capillary force lithography process, the patterned PDMS stamp served as top confinement to induce nanoparticle segregation. After annealing for desired time periods, the PDMS top layer was peeled off to reveal the polymer film surface. The nanoparticle organization was characterized with a JEOL JEM-1230 Transmission Electron Microscope (TEM) operated at 200 kV. Samples for TEM were prepared by pre-coating a thin layer (about 10 nm) of PSS solution prior to flow-coating blend films. The multilayer films were immersed into deionized water in a beaker, and PSS dissolved while the top polymer layer floated on water, thus allowing transferring onto TEM copper grids. Surface topography of the thin films was imaged using a Dimension Icon Atomic Force Microscope (AFM, Bruker AXS) under tapping mode.

Patterned Nanocomposite 1:

A first polymer nanocomposite was prepared with PS-g-TiO₂ nanoparticle assemblies in PS thin films. Top-view TEM images of the patterned PS-g-TiO₂/PS blend thin films were obtained. The imprinted pattern pitch was 750 nm and step height was 120 nm. The alternative dark and light regions corresponded to imprinted mesas and trenches, respectively. As seen in the magnified image, after imprinting, nearly all PS-g-TiO₂ nanoparticle assemblies, either individual particle or small clusters, were located at less confined mesa regions.

Patterned Nanocomposite 2:

A second polymer nanocomposite was prepared with PMMA-g-TiO₂ nanoparticle assemblies in PMMA thin film. Top-view TEM images of the patterned TiO₂-PMMA/PMMA blend thin films were obtained. The imprinted pattern pitch was 750 nm and step height was 120 nm. The alternative dark and light regions corresponded to imprinted mesas and trenches, respectively. As seen from TEM images, after imprinting, nearly all TiO₂-PMMA nanoparticles, either individual particle or small clusters, were located at less confined mesa regions.

In light of the foregoing, it should be appreciated that the present invention advances the art by providing improved nanoparticle-containing micro/nano-structures and associate methods of production. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A polymer nanocomposite comprising a polymer matrix having nanoparticle assemblies and free polymer chains, the free polymer chains having a radius of gyration size, each of the nanoparticle assemblies having polymers tethered to a nanoparticle, the nanoparticle assemblies having a size larger than the radius of gyration of the free polymer chains.

2. The polymer nanocomposite of claim 1, the tethered polymers of the nanoparticle assemblies having a thickness extending from the outer surface of the nanoparticle to the outer surface of the tethered polymers, wherein the tethered polymer thickness is at least two times greater than the radius of gyration of the free polymer chains.

3. The polymer nanocomposite of claim 1, the tethered polymers of the nanoparticle assemblies having a thickness extending from the outer surface of the nanoparticle to the outer surface of the tethered polymers, wherein the tethered polymer thickness is less than the radius of gyration of the free polymer chains.

4. The polymer nanocomposite of claim 1, wherein the nanoparticles are spherical and have a radius that is greater than the radius of gyration of the free polymer chains.

5. The polymer nanocomposite of claim 1, wherein the nanoparticles are spherical and have a radius of 100 nm or less.

6. The polymer nanocomposite of claim 1, wherein the nanoparticles are non-spherical and have at least one dimension of 100 nm or less.

7. The polymer nanocomposite of claim 1, the nanoparticle assemblies having a radius extending from the center of the nanoparticle to the outer surface of the tethered polymers, the radius of the nanoparticle assemblies being in the range of from 5 nm to 5 μm.

8. The polymer nanocomposite of claim 1, the polymer nanocomposite having a first protruding pattern and a second protruding pattern, a trench section extending between the first protruding pattern and the second protruding pattern, the first protruding pattern and the second protruding pattern each having a higher composition of nanoparticle assemblies than the trench section.

9. The polymer nanocomposite of claim 1, the nanoparticle assemblies including a first subset of nanoparticle assemblies characterized by a first property and a second subset characterized by a second property, wherein the first subset of nanoparticle assemblies are characterized by a first size and the second subset of nanoparticle assemblies are characterized by a second size different from the first size.

10. The polymer nanocomposite of claim 1, the nanoparticle assemblies including a first subset of nanoparticle assemblies characterized by a first property and a second subset characterized by a second property, wherein the first subset of nanoparticle assemblies are characterized as being made from a first material and the second subset of nanoparticle assemblies are characterized as being made from a second material different from the first material.

11. The polymer nanocomposite of claim 1, the polymer nanocomposite having a first protruding pattern and a second protruding pattern, a trench section extending between the first protruding pattern and the second protruding pattern, the nanoparticle assemblies including a first subset of nanoparticle assemblies characterized by a first property and a second subset characterized by a second property, wherein the first subset of nanoparticle assemblies are selectively migrated in the first protruding pattern and the second protruding pattern, and wherein the second subset of nanoparticle assemblies are selectively migrated in the trench section.

12. The polymer nanocomposite of claim 1, wherein the free polymer chains and tethered polymers are made from the same material.

13. The polymer nanocomposite of claim 1, wherein the free polymer chains and tethered polymers are made from different materials.

14. A method of making the polymer nanocomposite of claim 1 comprising the steps of:
providing a substrate with a nanoparticle assembly-containing film thereon, the nanoparticle assembly-containing film including the nanoparticle assemblies and the free polymer chains;
positioning a patterned object having patterns therein on the nanoparticle assembly-containing film;
while the nanoparticle assembly-containing film is in contact with the patterned object, annealing the nanoparticle assembly-containing film by a step selected from solvent annealing and temperature-based annealing, said step of annealing causing the nanoparticle assembly-containing film to conform to the patterns of the patterned mask;
allowing the nanoparticle assemblies of the nanoparticle assembly-containing film to selectively migrate into the patterns of the patterned mask;
removing the patterned object from the nanoparticle assembly-containing film to thereby form a patterned nanoparticle-containing material having one or more patterns, the nanoparticle assemblies being selectively migrated in the patterns of the patterned nanoparticle-containing material.

15. The method of claim 14, wherein the method is a continuous, roll-to-roll process.

16. The method of claim 14, the free polymer chains and the tethered polymers being made from the same material.

17. A polymer nanocomposite comprising a polymer matrix having nanoparticle assemblies and free polymer chains, the free polymer chains having a radius of gyration size, each of the nanoparticle assemblies having polymers tethered to a nanoparticle, the free polymer chains and the tethered polymers being made from the same material.

18. A patterned polymer nanocomposite assembly comprising a substrate having a patterned film thereon, the patterned film including nanoparticle assemblies within a polymer matrix, each of the nanoparticle assemblies having polymers tethered to a nanoparticle, the patterned film including a first pattern, a second pattern, a trench section extending between the first pattern and the second pattern, the first pattern and the second pattern having a higher composition of nanoparticle assemblies than the trench section.
